(19) United States
(12) Patent Application Publication
(10) Pub. No.: US 2025/0383469 A1
(43) Pub. Date: Dec. 18, 2025

(54) User-Reconfigurable Metal Detector System and Method Therefor

(71) Applicant: Garrett Electronics, Inc., Garland, TX (US)

(72) Inventors: Stephen M. Novakovich, JR., Dallas, TX (US); J. Brian Head, Frisco, TX (US)

(73) Assignee: Garrett Electronics, Inc., Garland, TX (US)

(21) Appl. No.: 18/745,691

(22) Filed: Jun. 17, 2024

(51) Int. Cl. G01V 3/38; G01V 3/10

(52) U.S. Cl. CPC G01V 3/38; G01V 3/10

(57) ABSTRACT

Systems and techniques for reconfiguring a metal detector. In embodiments, the metal detector includes a current product profile with a first set of features selected from a set of available features. The current product profile facilitates a first classification of metal detecting operations. In embodiments, a request to reconfigure the metal detector and modify the current product profile based on the request is received. The modification results in a modified product profile that facilitates a second classification of metal detecting operations of the metal detector. The reconfiguration of the metal detector is performed without replacing hardware components of the metal detector. The reconfiguration allows for the metal detector to be upgraded, downgraded, or modified to suit different user requirements or applications.

### TECHNICAL FIELD

The present disclosure relates generally to metal detectors, and more particularly to a user-reconfigurable metal detector.

### BACKGROUND

Metal detectors are wonderful devices designed to detect the presence of metals within a surrounding area. They operate by generating a magnetic field and analyzing the response from metal objects when this field is disturbed. Metal detectors are widely used in various applications, including security screening at airports, construction to locate buried utilities, archaeology for uncovering historical artifacts, and by hobbyists for treasure hunting. Metal detectors can range from handheld units to larger (and often more complex) systems and are valued for their ability to locate metal objects that are not readily visible or accessible, providing a means for non-invasive exploration of various environments.

Metal detectors have been in use for over seven decades, with advancements and improvements being made in response to user requirements and emerging technologies. The development of digital metal detectors in the 1970s, which utilized microprocessors for control functions and signal processing, marked a major milestone in the evolution of metal detectors. As microprocessors became more powerful, signal processing evolved from simple measurement and display to full digital signal processing systems.

One notable feature of these digital systems was the ability to update the operation of the metal detector through software patches that were used to patch and fix bugs and secure the system. Typically, these updates are performed by the manufacturer or a repair shop.

However, the features, capabilities, and functionality of a metal detector are typically set during manufacturing, with limited upgrade capabilities available afterwards. For example, metal detectors are typically manufactured in a variety of models, each offering a distinct set of features. These features, which can range from detection capabilities to user interface design, are predetermined at the time of manufacturing. Consequently, if a customer desires to upgrade or change their metal detecting capabilities, the customer is generally forced to replace their current metal detector with a different model of the metal detector that comes with the desired features, often by purchasing the new metal detector.

For example, a customer who initially purchases an entry-level metal detector, equipped with basic features, would find themselves restricted to the functionalities offered by this entry-level metal detector. If the customer wishes to access more advanced features or a higher level of performance, the customer may have to invest in a higher-level metal detector. This upgrade process often involves a substantial additional expenditure, making it a costly endeavor for the customer.

Conversely, a customer may purchase a higher-end metal detector model, including extensive and advanced features, only to later discover that many of these features are not necessary for the customer's specific metal detecting activities. Such a customer is then left with a device that includes features that are not being utilized. Perhaps worse still, this customer may benefit from some of the advanced features but may find that they would prefer or require lower-end features for some specific aspects of the metal detecting activities. This mismatch can leave the customer with a device that is not fully aligned with their individual needs, as they are unable to combine advanced and basic features within a single model.

The deficiencies of current metal detector cause customers to face particular constraints when their metal detecting requirements span across different applications or use cases. If a customer purchases a metal detector that is specifically tailored for one application, such as relic hunting, and later decides to engage in a different metal detecting activity, like gold prospecting or law enforcement searches, the customer may be forced to purchase an entirely separate metal detector designed for that new application. This is because the features and functionalities of their existing metal detector are optimized for the initial use case and are not readily transferable or adaptable to the new application. This inflexibility not only forces customers to incur additional costs by buying multiple metal detectors for different applications but also leads to the underutilization of their original equipment.

### SUMMARY

The present disclosure achieves technical advantages as systems, methods, and computer-readable storage media for a user-reconfigurable metal detector. The present disclosure provides for a system integrated into a practical application with meaningful limitations as an integrated system with functionality for user-reconfiguration of a metal detector that overcomes the limitations of traditional, model-centric metal detectors by providing a flexible and user-customizable platform. The reconfigurable metal detector of embodiment may be built upon a common hardware platform consisting of fixed hardware components that do not change during reconfiguration. Instead of replacing hardware components to upgrade, downgrade, or modify the functionality of the metal detector, reconfiguration may be achieved through software by enabling or disabling features and by replacing the current product profile with a different product profile that includes a distinct set of features.

In embodiments, the system of embodiments allows users to reconfigure the metal detector to support different classifications of metal detecting operations, which may represent varying levels of accuracy, power, performance, or specific metal detecting applications such as relic hunting, law enforcement, gold hunting, or coin hunting. Each classification of operations is facilitated by a product profile that encompasses a cooperative operation of a set of features selected from the set of available features associated with the reconfigurable metal detector.

In embodiments, users may be enabled to reconfigure the current product profile by adding new features to enhance the metal detector's capabilities, removing features that are no longer desired, enabling features to expand the metal detector's functionality, disabling features to streamline operations, or replacing the current product profile with a new one that better suits their evolving metal detecting requirements. This user-driven reconfiguration process can be performed by the user themselves, without the metal detector needing to be taken to a shop for reconfiguration.

As such, the present disclosure provides for a reconfigurable metal detector system that provides a cost-effective and adaptable solution, allowing users to tailor their device to their specific requirements and applications, and to evolve with their metal detecting journey. This innovative approach to metal detector design offers a sustainable and future-proof platform for users to enjoy a personalized metal detecting experience.

Another significant technical improvement provide by the system of embodiments is that it provides a solution that addresses the inflexibility and cost-inefficiency of traditional metal detectors. For example, the reconfigurable metal detector system enables users to perform on-the-fly customization of their device's features without the replacement of hardware components. This may be achieved through a software-driven approach that allows for the enabling or disabling of features, as well as the swapping of product profiles, which include a distinct set of features tailored to specific metal detecting operations.

Another technical improvement is the system's ability to support multiple product profiles on a single hardware platform. This functionality allows users to switch between different classifications of metal detecting operations, such as relic hunting, law enforcement, gold hunting, or coin hunting, without the purchase of separate, specialized devices, providing users with a versatile tool that can adapt to various metal detecting scenarios.

Still another technical improvement includes the system's ability to enable user with a user-driven reconfiguration process that can be performed independently, eliminating the traditional reliance on manufacturers or service centers for upgrades or modifications. This self-service model not only enhances the user experience by provides greater control over the device's functionality and reduces downtime and associated costs.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for metal detector reconfiguration. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of reconfiguring a metal detector. It is a further object of the disclosure to provide a system for reconfiguring a metal detector, and a computer-based tool for reconfiguring a metal detector. These and other objects are provided by the present disclosure, including at least the following embodiments.

In one particular embodiment, a method of reconfiguring a metal detector is provided. The method includes configuring a metal detector with a current product profile. In embodiments, the current product profile includes a first set of features selected from a set of available features associated with the metal detector, the set of available features is constructed from a set of capabilities associated with hardware components of the metal detector, and the current product profile facilitates a first classification of metal detecting operations of the metal detector. The method also includes receiving a request, via an update system, to reconfigure the metal detector. In embodiments, the request to reconfigure the metal detector includes a request to modify the current product profile. The method further includes validating the request to reconfigure the metal detector via the update system, and reconfiguring, in response to a successful validation of the request to reconfigure the metal detector, the metal detector to modify the current product profile based on the validated request to reconfigure. In embodiments, the modified current product profile facilitates a second classification of metal detecting operations of the metal detector.

In another embodiment, a system for reconfiguring a metal detector is provided. The system comprises at least one processor and a memory operably coupled to the at least one processor and storing processor-readable code that, when executed by the at least one processor, is configured to perform operations. The operations include configuring a metal detector with a current product profile. In embodiments, the current product profile includes a first set of features selected from a set of available features associated with the metal detector, the set of available features is constructed from a set of capabilities associated with hardware components of the metal detector, and the current product profile facilitates a first classification of metal detecting operations of the metal detector. The operations also include receiving a request, via an update system, to reconfigure the metal detector. In embodiments, the request to reconfigure the metal detector includes a request to modify the current product profile. The operations further include validating the request to reconfigure the metal detector via the update system, and reconfiguring, in response to a successful validation of the request to reconfigure the metal detector, the metal detector to modify the current product profile based on the validated request to reconfigure. In embodiments, the modified current product profile facilitates a second classification of metal detecting operations of the metal detector.

In yet another embodiment, a computer-based tool for reconfiguring a metal detector is provided. The computer-based tool including non-transitory computer readable media having stored thereon computer code which, when executed by a processor, causes a computing device to perform operations. The operations include configuring a metal detector with a current product profile. In embodiments, the current product profile includes a first set of features selected from a set of available features associated with the metal detector, the set of available features is constructed from a set of capabilities associated with hardware components of the metal detector, and the current product profile facilitates a first classification of metal detecting operations of the metal detector. The operations also include receiving a request, via an update system, to reconfigure the metal detector. In embodiments, the request to reconfigure the metal detector includes a request to modify the current product profile. The operations further include validating the request to reconfigure the metal detector via the update system, and reconfiguring, in response to a successful validation of the request to reconfigure the metal detector, the metal detector to modify the current product profile based on the validated request to reconfigure. In embodiments, the modified current product profile facilitates a second classification of metal detecting operations of the metal detector.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for user-reconfiguration of a metal detector in accordance with embodiments of the present disclosure.

FIG. 2A is a block diagram of an exemplary user-reconfigurable metal detector configured with capabilities and functionality for user-reconfiguration in accordance with embodiments of the present disclosure.

FIG. 2B is a diagram illustrating an exemplary configuration of the user-reconfigurable metal detector configured with capabilities and functionality for user-reconfiguration in accordance with embodiments of the present disclosure.

FIG. 3 is a block diagram of an exemplary update system configured with capabilities and functionality for reconfiguring a user-reconfigurable metal detector in accordance with embodiments of the present disclosure.

FIG. 4A illustrates a sequence diagram that shows exemplary operations for reconfiguring a reconfigurable metal detector in accordance with embodiments of the present disclosure.

FIG. 4B illustrates a sequence diagram that shows exemplary operations for reconfiguring a reconfigurable metal detector in accordance with embodiments of the present disclosure.

FIG. 5 is a flowchart illustrating operations for reconfiguring a user-reconfigurable metal detector in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to a user-reconfigurable metal detector system and methods thereof. The system of embodiments may be configured to provide functionality for a user to reconfigure a reconfigurable metal detector (e.g., to upgrade, modify, etc.) through a software-driven process, without the replacement of hardware components. This flexibility allows for the customization of the reconfigurable metal detector's functionality to suit a variety of applications and user preferences, without the need for the user to purchase a new metal detector. The reconfigurable metal detector may include a common hardware platform, which remains constant during reconfiguration, and a set of available features that can be changed, enabled, disabled, added, or removed to alter the functionality of the metal detector. In embodiments, reconfiguring the reconfigurable metal detector may include replacing a current product profile having a set of features of the reconfigurable metal detector with a new product profile having a different set of features. The system of embodiments may include an update system (e.g., including a backend system and a local installer), which is configured to facilitate the reconfiguration process.

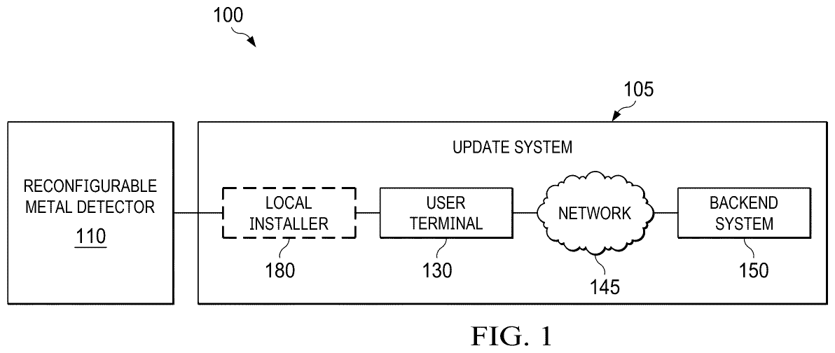

FIG. 1 is a block diagram of an exemplary system 100 configured with capabilities and functionality for user-reconfiguration of a metal detector in accordance with embodiments of the present disclosure. As shown in FIG. 1, system 100 may include a user-reconfigurable metal detector 110, an update system 105, a user terminal 130, and a network 145. The update system 105 may include a local installer 180 and a backend system 150. These components, and their individual components, may cooperatively operate to provide functionality in accordance with the discussion herein. In particular, the reconfigurable metal detector system 100 is configured to enable customization and/or reconfiguration of the user-reconfigurable metal detector 110, allowing users to modify the current product profile and/or individual features to suit their specific metal detecting requirements. Users may interact with the backend system 150 to request a reconfiguration (e.g., modification) of the user-reconfigurable metal detector 110, which may include selecting features to change, add, remove, enable, or disable, or choosing a new product profile to replace the current product profile of the user-reconfigurable metal detector 110. Alternatively, the modifications may be requested through the interface of the local installer 180. Once a reconfiguration request is made, the request may undergo a validation process to ensure that the selected feature or product profile is authorized for the user-reconfigurable metal detector 110, which may depend on whether the modification has been purchased or is available for free. If the reconfiguration request is validated, the local installer 180 communicates with the metal detector 110, sending the appropriate files, code, signals, and/or commands to execute the reconfiguration. This process may transform the metal detector into a versatile tool that can be tailored to various metal detecting activities, applications, and user preferences without the expense and inconvenience of purchasing multiple, fixed-functionality devices.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate a user interacting with the system 100, e.g., via the network 145, to execute and leverage the features provided by the cooperative operations of the system 100. It is noted that although the user terminal 130 may be illustrated as part of update the system 105, in embodiments, the user terminal 130 may include a component that is separate and distinct from the update system 105, and as such, the illustration of the user terminal 130 as part of the update system 105 is for illustrative purposes and not by way of limitation.

In embodiments, the user terminal 130 may be configured to operate as the interface for user interaction with the reconfigurable metal detector system 100. In embodiments, the user terminal 130 may be configured to present a user interface generated by the local installer 180, which may provide a mechanism for users to initiate and manage the reconfiguration process of their metal detector. Additionally, or alternatively, the user terminal 130 may be configured to present a user interface provided by the backend system 150, which may be used by the user to access and select from a variety of features and product profiles available for their device. This dual capability provides a mechanism for interacting with the local installer 180 to make immediate changes and/or with the backend system 150 for a broader range of customization and/or reconfiguration options. In embodiments, user terminal 130 may be configured to communicate with other components of system 100.

In embodiments, the network 145 may facilitate communications between the various components of the system 100 (e.g., the user-reconfigurable metal detector 110, the backend system 150, the local installer 180, and/or the user terminal 130). The network 145 may include one or more of a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc. It is noted that although the network 145 may be illustrated as part of update system 105, in embodiments, the network 145 may include a component that is separate and distinct from update system 105, and as such, the illustration of the network 145 as part of the update system 105 is for illustrative purposes and not by way of limitation.

The user-reconfigurable metal detector 110 represents an innovative approach and solution to the deficiencies of current metal detecting devices. Unlike traditional metal detectors, which are static in their feature set post-manufacture, the user-reconfigurable metal detector 110 is configured to be dynamic and adaptable to the evolving and changing requirements of its users. This configuration of the user-reconfigurable metal detector 110 of embodiments allows for a single hardware platform to serve multiple purposes, to be configured for multiple classifications of metal detecting operations, which may include different performance levels and/or different metal detecting applications.

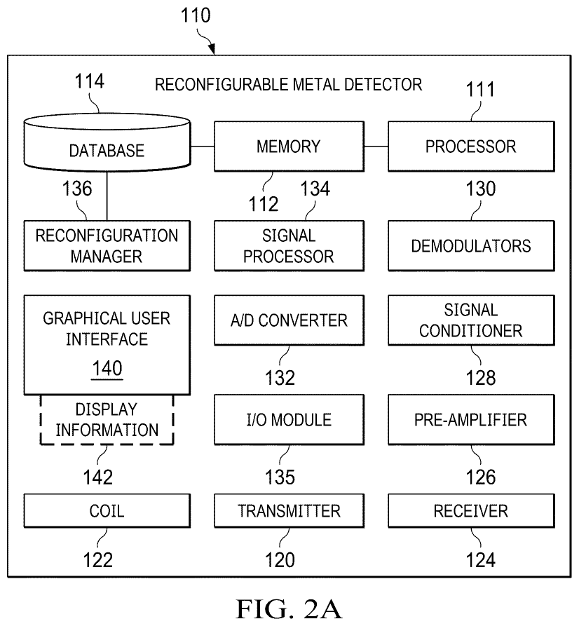

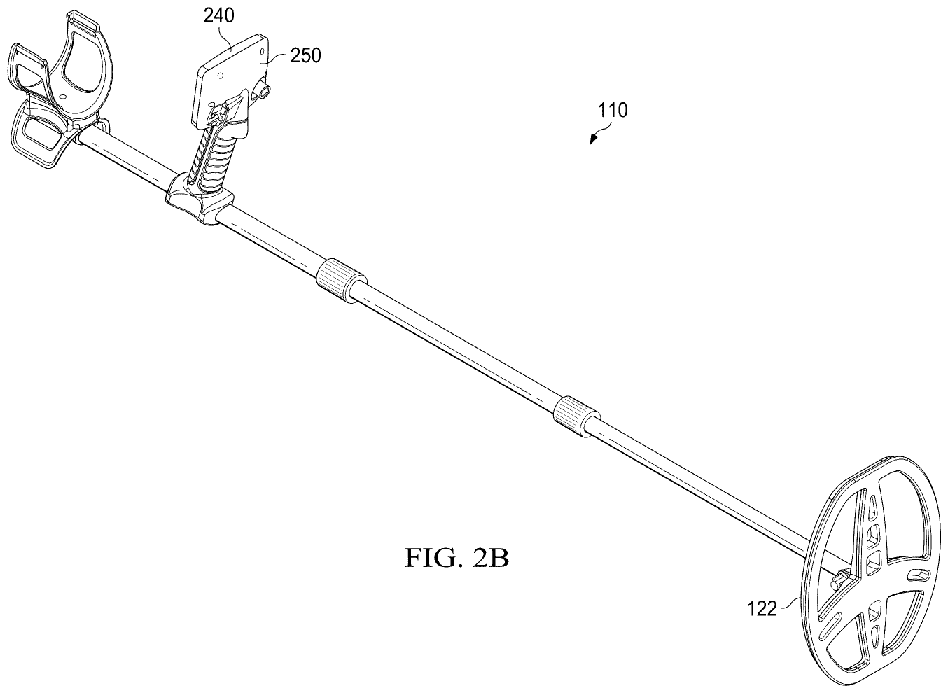

In embodiments, the user-reconfigurable metal detector 110 may include a set of hardware components that form a common hardware platform. These components are configured to provide a wide range of functionalities and capabilities, which remain constant throughout the life of the user-reconfigurable metal detector 110. A specific configuration of the user-reconfigurable metal detector 110 will now be discussed with reference to FIG. 2A.

FIG. 2A is a block diagram of an exemplary user-reconfigurable metal detector 110 configured with capabilities and functionality for user-reconfiguration in accordance with embodiments of the present disclosure. It is noted that the functional blocks, and components thereof, of the user-reconfigurable metal detector 110 illustrated in FIG. 2A may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of the user-reconfigurable metal detector 110 illustrated in FIG. 2A are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of the user-reconfigurable metal detector 110 illustrated in FIG. 2A described herein is provided for purposes of illustration, rather than by way of limitation and that functionalities described as being provided by different functional blocks may be combined into a single component or may be provided via computing resources disposed in a cloud-based environment accessible over a network.

As shown in FIG. 2A, the user-reconfigurable metal detector 110 may include various components, such as a processor 111, and a memory 112. In embodiments, the memory 112 may comprise a processor readable medium configured to store one or more instruction sets (e.g., software, firmware, etc.) which, when executed by a processor (e.g., one or more processors of the processor 111), perform tasks and functions as described herein. The user-reconfigurable metal detector 110 may include a transmitter 120 configured to generate a transmit wave, a coil 122 configured to generate a magnetic field in response to the transmit wave produced by the transmitter 120, and a receiver 124 configured to capture the receive signal that is generated when the magnetic field produced by the coil 122 interacts with a metallic object. In embodiments, the user-reconfigurable metal detector 110 may include a pre-amplifier 126 configured to amplify the receive signal detected by the coil 122 and captured by the receiver 124, a signal conditioner 128 configured to condition the amplified receive signal from the pre-amplifier 126, one or more demodulators 130 configured to demodulate the conditioned receive signal provided by the signal conditioner 128, an analog-to-digital (A/D) converter 132 configured to convert the analog demodulated signal from the demodulators 130 into a digital format to enable the subsequent digital processing of the signal by the signal processor 134, and a signal processor 134 configured to analyze the digital signal provided by the A/D converter 132 to provide metal detecting functionality. The user-reconfigurable metal detector 110 may include an input/output (I/O) module 135 configured to operate as a communication interface between the metal detector and external devices, such as the local installer 180, and a user interface 140 configured to facilitate interaction between the user and the user-reconfigurable metal detector 110.

FIG. 2B is a diagram illustrating an exemplary configuration of the user-reconfigurable metal detector 110 configured with capabilities and functionality for user-reconfiguration in accordance with embodiments of the present disclosure. As shown in FIG. 2B, the user-reconfigurable metal detector 110 may be implemented as a hand-held device for ease of use and portability. This particular configuration of the user-reconfigurable metal detector 110 may be configured to meet the demands of users who require a metal detector that can be operated with one hand.

In embodiments, the user-reconfigurable metal detector 110 may include a display 240, which may incorporate the capabilities and functionality of the user interface 140. The display 240 may operate as the interface with the user and may be configured to present information such as detection results, device settings, and battery status. In embodiments, the display 240 may be a touch-sensitive screen, allowing users to interact directly with the graphical user interface to adjust settings, switch between detection modes, access advanced features of the metal detector, and/or to request reconfiguration of the metal detector.

In embodiments, the housing 250 of the user-reconfigurable metal detector 110 may be configured to house and protect the internal hardware components while maintaining a lightweight and ergonomic form factor. The housing 250 may be constructed from durable materials that can withstand outdoor use, including exposure to elements such as dust, moisture, and varying temperatures. Within the housing 250, hardware components such as the processor 111, memory 112, transmitter 120, receiver 124, and/or other hardware components may be arranged to optimize the metal detector's performance while ensuring balance and comfort for the user. In some embodiments, the housing 250 may include a grip with a non-slip surface, providing a secure hold during operation and reducing fatigue over extended periods of use.

In this configuration, the user-reconfigurable metal detector 110 may also include a speaker or audio output integrated into the housing 250, allowing for audible signals to be emitted when metal targets are detected. The audio feedback may be customized through the display 240, enabling users to set different tones or volume levels based on the type of metal detected or personal preference.

With reference back to FIG. 1, in embodiments, the functionality of the user-reconfigurable metal detector system 100 may include functionality for creating and/or generating a set of available features associated with the user-reconfigurable metal detector 110. The set of available features may be derived from the functionality and capabilities of the hardware components within the metal detector. For example, the functionality of the transmitter 120, which may be configured to generate the transmit wave, may be managed by the functionality of the processor 111. In this example, the functionality of the transmitter 120 and the processor 111 with respect to the generation of the transmit wave may be combined to form a feature that allows users to control characteristics of the transmit wave. In particular, a feature related to the frequency of the transmit wave may be formed. This feature, which may be referred to as the “transmit wave frequency” feature, may enable configuration of the frequency of the transmit wave, and may be leveraged by the user-reconfigurable metal detector 110 to tune the user-reconfigurable metal detector 110 for different detection scenarios, such as adjusting the frequency to improve detection of small objects or to penetrate deeper into the ground.

In another example, the capabilities of the coil 122 and the receiver 124 may be combined to form a “signal analysis” feature. This signal analysis feature may leverage the coil 122's ability to detect subtle changes in the magnetic field and the receiver 124's precision in capturing the receive signal to provide detailed information about the detected metal objects. The signal analysis feature may be configured with various levels of performance, from basic metal identification to advanced discrimination settings that allow users to filter out unwanted metallic noise and focus on specific target metals.

In a further example, the functionality of the signal processor 134 may be used to form a “target characterization” feature. This feature may use the digital signal analysis capabilities of the signal processor 134 to provide users with insights into the size, shape, and composition of detected objects. In still another example, the capabilities and functionalities of the user interface 140 may be used to form a “customizable display” feature. This feature may allow users to personalize the information presented on the screen, such as selecting which detection parameters to display, customizing the layout of the interface, and choosing how target information is represented visually.

In the same manner, other features associated with the user-reconfigurable metal detector 110 may be formed leveraging the functionality, combined or individual, of the various hardware components of the user-reconfigurable metal detector 110. Indeed, other particular features that may be included in the set of available features of the user-reconfigurable metal detector 110 will be discussed in more detail below.

In embodiments, the features formed may be included in the set of available features associated with the user-reconfigurable metal detector 110. In this manner, the set of available features associated with the user-reconfigurable metal detector 110 may represent a set of features that are available to be installed, enabled, or otherwise implemented in the user-reconfigurable metal detector 110. In embodiments, each feature in the set of available features associated with the user-reconfigurable metal detector 110 may represent a specific functionality provided by the arrangement or capability of one or more hardware components.

In embodiments, one or more features of the set of available features associated with the user-reconfigurable metal detector 110 may be configurable with varying levels of performance. This is in contrast with one or more one or more features of the set of available features associated with the user-reconfigurable metal detector 110 that may be configurable as either enabled or disabled, with nor varying levels of performance. The varying levels of performance may provide a spectrum of operational capabilities associated with an available feature that can be tailored to specific metal detecting requirements and/or operations. For example, an available feature that defines the number of frequencies that can be used in a multi-frequency configuration can have different levels, each offering a distinct number of frequencies to enhance detection capabilities. For example, at a first level, this available feature may include the use of 2 frequencies, at a second level this available feature may include an increased number of frequencies to 4, and at a third level this available feature may include an increased number of frequencies to 7.

In embodiments, the set of available features associated with the user-reconfigurable metal detector 110 may include features such as a “Detection Performance Comparison” feature, a “Cumulative Increased Detection Depth” feature, an “Iron Volume” feature, a “Volume Control” feature, a “Screen Backlight” feature, a “Number of Tones” feature, an “Iron Audio” feature, a “Multi-Frequency” feature, a “Number of Discrimination Modes” feature, a “Wireless Mode” feature, a “Phase Roll Target ID” feature, a “Multi-Dimensional Multi-Frequency” feature, a “Target ID Scale/Graphs” feature, a “Frequency Shift” feature, a “Pinpoint Mode” feature, a “Ground Balance” feature, a “Variable Recovery/Reactivity” feature, software-affected physical features, where software commands may enable or disable hardware components, resulting in changes to the metal detector's physical functionality.

It is noted that the specific features described herein as part of the set of available features for the user-reconfigurable metal detector are provided for illustrative purposes and are not intended to be exhaustive or to limit the disclosure in any manner. In some embodiments, the metal detector may include additional features not explicitly mentioned or discussed herein, which may offer further enhancements or specialized functionalities tailored to the diverse requirements of metal detecting operations.

In embodiments, the user-reconfigurable metal detector 110 may be configured with a product profile that includes a set of features selected from the set of available features. In embodiments, the product profile with which the user-reconfigurable metal detector 110 may be configured may represent a tailored configuration that represents a combination of selected features from the set of available features, designed to meet the specific operational, commercial, design, and/or other types of requirements and/or preferences. For example, a product profile may be generated or constructed by selecting a set of features from the set of available features, such as described herein. Once this selection of features is made, the selected set of features is included in the product profile.

In embodiments, the process of creating, constructing, or generating a product profile may include enabling the user to interact with the local installer 180 and/or the backend system 150 to view the set of available features associated with the user-reconfigurable metal detector 110, and to select from the set of available features. The user's selections may be compiled into a product profile that may be installed onto the user-reconfigurable metal detector 110. In some embodiments, the generated product profile may be stored in the backend system 150 and/or the local installer 180. In some embodiments, pre-generated product profiles may be provided that may be selected for configuring the user-reconfigurable metal detector 110. These pre-generated product profiles may be generated or curated by the manufacturer, and or by other users or experts. The pre-generated may be stored in the backend system 150 and/or the local installer 180 and may be made available to the user for installation onto the user-reconfigurable metal detector 110.

In embodiments, the configuration of the product profile may define a configuration for each of the features in the set of features included in the product profile. For example, in embodiments, for each feature selected to be part of a product profile, there may be a specific configuration that determines how that feature will operate within the context of the metal detector's operations. For example, a feature such as the Number of Tones feature may be included in a product profile and may be configured at a particular level for that profile. For example, the Number of Tones feature may be included in a product profile and may be configured with three tones. However, in another product profile, the Number of Tones feature may also be included but may be set at a higher level with more tones, such as the second or third level.

In embodiments, features within the set of available features may not be configurable with multiple levels of performance but instead may be configured in a binary manner as either enabled or disabled within a product profile. For example, product profiles may include the Iron Volume feature. In one product profile, the Iron Volume feature may be configured as disabled, meaning that the functionality associated with this feature is not active, and the metal detector configured with this product profile will not provide differentiated audio feedback for iron targets. Conversely, another product profile may also include the Iron Volume feature, but in this case, the feature may be configured as enabled. When the feature is enabled, the metal detector configured with this product profile will offer the functionality of the Iron Volume feature, allowing the user to adjust the volume of the audio signals for iron targets. This may enable users to lower the volume for less desirable targets, such as iron, while maintaining higher volume levels for more valuable targets.

It is noted that while the set of available features associated with the reconfigurable metal detector 110 may include a wide array of features, not all available features may be included in a particular product profile. The set of available features represents the full spectrum of capabilities that the metal detector's hardware and software can support. However, the inclusion of these features in a product profile is subject to their selection for inclusion in the product profile.

In embodiments, once a product profile has been established or constructed, the user-reconfigurable metal detector 110 may be configured to leverage the functionality of the included set of features, enabling the user-reconfigurable metal detector 110 to perform according to the functionality provided by the product profile. Each feature within the product profile may contribute to the overall performance and/or functionality of the user-reconfigurable metal detector 110.

In embodiments, each feature included in a product profile may be integrated into the operation of the user-reconfigurable metal detector 110, providing a cohesive metal detecting operation. By configuring the user-reconfigurable metal detector 110 with a product profile that includes a specific set of features, the user-reconfigurable metal detector 110 may be optimized for operations.

In embodiments, a plurality of product profiles may be provided for configuring a user-reconfigurable metal detector. Each product profile of the plurality of product profiles may be configured designed to cater to the diverse preferences and requirements of users. In embodiments, each product profile of the plurality of product profiles may include a different sets of features including features selected from the set of available features for the metal detector. In embodiments, the difference between the product profiles of the plurality of product profiles may include a difference in the number of features. For example, a first product profile may have fewer features compared to a second product profile, reflecting a more basic or entry-level configuration. The first product profile may be suitable for beginners or users who prefer simplicity in their metal detecting activities. Conversely, the second product profile, with a greater number of features, may offer advanced capabilities for experienced users or those seeking a more sophisticated metal detecting experience.

In embodiments, the difference between the product profiles of the plurality of product profiles may include a difference in the configuration of individual features. For example, one or more features may be included in a first and second profiles. However, in the second product profile, the one or more features may be configured with a higher level than the level at which the one or more features are configured in the first profile. In this case, the second product profile may be considered to be higher or an upgrade from the first profile, as it provides a higher level of functionality and adaptability to various metal detecting conditions. For example, both the first and second product profiles may include the Multi-Frequency feature. However, in the first product profile, this feature may be configured to operate with two frequencies, while the second product profile may configure the Multi-Frequency feature with four frequencies, offering enhanced detection performance. In this example, the second product profile may be considered an upgrade from the first product profile.

In embodiments, the different product profiles of the plurality of product profiles available for configuring the reconfigurable metal detector 110 may be configured to facilitate different classifications of metal detecting operations of the metal detector. In some embodiments, the classifications of metal detecting operations may include the levels of performance that may be achievable based on the functionality of the configured product profile. For example, a first product profile may be configured to facilitate a basic classification of metal detecting operations, suitable for beginner users or those who engage in metal detecting as a leisure activity. In embodiments, the first product profile may include a limited set of features, such as basic discrimination modes and a fixed frequency operation, which may provide a straightforward and user-friendly metal detecting experience.

On the other hand, a second product profile may be configured to support a more advanced classification of metal detecting operations, offering a higher level of performance than the first product profile. This could be due to the inclusion of features in the second product profile that are configured at a higher level, such as enhanced multi-frequency feature, higher ground balancing algorithms, and a higher number of discrimination modes, among other features. In embodiments, a user-reconfigurable metal detector configured with the second product profile may be capable of more complex detection tasks, such as identifying a wider range of metal types, operating effectively in varied terrains, and providing more detailed information about detected targets. Consequently, users who are more experienced or who have specific metal detecting goals, such as professional relic hunters or gold prospectors, may find this advanced product profile more aligned with their requirements.

In some embodiments, a product profile configured to enable or support a higher classification of metal detecting operations may include features that are configured at a higher level of performance than a product profile configured to enable or support a lower classification of metal detecting operations. For example, while both a first and second product profiles may include a Target ID Scale/Graphs feature, the first product profile may configure this feature with a basic numerical scale for target identification, whereas the second product profile may configure this feature with a more detailed graphical representation.

In embodiments, configuring the different product profiles of the plurality of product profiles available for configuring the user-reconfigurable metal detector 110 to facilitate different classifications of metal detecting operations of the metal detector may allow for dynamic reconfiguration of product profiles to match the evolving skills and interests of the user. As users gain experience and refine their metal detecting techniques, the users may opt to transition from a product profile that supports basic operations to one that enables more advanced operations. This progression is facilitated by the reconfigurable nature of the user-reconfigurable metal detector 110, which in this case may be updated to reflect the user's current level of expertise without the inconvenience of purchasing a new device.

In embodiments, the different product profiles with which the user-reconfigurable metal detector 110 may be configured may include a product profile configured for entry level performance, a product profile configured for a medium level of performance higher than the entry level of performance, and product profile configured for an advanced level of performance that is higher than the medium level of performance.

In embodiments, the classifications of metal detecting operations that the different product profiles of the plurality of product profiles available for configuring the reconfigurable metal detector 110 may be configured to facilitate or support may include metal detecting applications for which the functionality of the product profile (e.g., the functionality of the set of features included in the product profile) may be tailored. For example, in embodiments, different product profiles may be configured or tailored to facilitate or enable different metal detecting applications. For example, a first product profile may be configured to support a classification of operations that includes beach treasure hunting, while a second product profile may be tailored for relic hunting in historical sites. These metal detecting application-based classifications may be indicative of the metal detecting application for which the metal detector is optimized when configured with the respective product profile.

In embodiments, the different product profiles with which the user-reconfigurable metal detector 110 may be configured may include a law enforcement product profile specifically configured for security and law enforcement applications, a relic hunting product profile configured to support operations for searching for relics and archaeological objects, a treasure hunting product profile that may be configured to support operations aimed at detecting jewelry, coins, and other valuable items, an industrial and commercial product profile configured for metal detecting operations for industrial and commercial applications, and a gold hunting product profile that may be configured for detecting gold objects.

It is noted that the product profiles (e.g., performance-based and/or application-based) described herein represent a non-limiting example of the functionality of the user- reconfigurable metal detector 110, and should not be construed as limiting in any way. Indeed, in embodiments, other product profiles may be provided.

In embodiments, the user-reconfigurable metal detector 110 may be configured to allow a user to reconfigure the user-reconfigurable metal detector 110 between different product profiles. The functionality of the user-reconfigurable metal detector 110 to enable a user to reconfigure the user-reconfigurable metal detector 110 enables the user to adapt the user-reconfigurable metal detector 110 to a variety of metal detecting scenarios without the expense and inconvenience of purchasing a new metal detector hardware. For example, a user may initially purchase a metal detector with a basic product profile suitable for general metal detecting. As the customer's interest and skill level grow, the customer may choose to download, install, and/or activate a higher performance product profile, unlocking advanced features and enhancing the detector's capabilities, without the need or expense of a new metal detector.

In embodiments, the functionality for reconfiguring the user-reconfigurable metal detector 110 may include functionality to replace the current product profile of functionality with a different product profile. In embodiments, the user may access the update system 105 to browse and select from a range of available product profiles associated with the user-reconfigurable metal detector 110. Once a new product profile is purchased or otherwise acquired, the new product profile may be downloaded and/or installed on the user-reconfigurable metal detector 110, replacing the current product profile. In some embodiments, rather than downloading a file or structure to the metal detector, installing the new product profile may include modifying (e.g., upgrading, downgrading, enabling, disabling, etc.) the set of features of the current product profile such that the modified set of features aligns with the configuration of the new product profile.

For example, a user may replace a current product profile optimized for coin hunting with a new product profile designed for deep relic hunting. The new product profile may include a set of features that is different from the set of features of the current product profile. By activating this new product profile, the user may more effectively perform the relic hunting configured to handle the challenges of the relic hunting application.

In another example, the user-reconfigurable metal detector 110 may be configured with an entry level product profile. In this example, the user may replace the current entry level product profile with a higher medium level product profile. In this manner, the user-reconfigurable metal detector 110 may be configured with higher level performance without having to replace the hardware components, and the user may leverage the higher performance of the metal detector without having to replace the metal detector.

In embodiments, the functionality for reconfiguring the user-reconfigurable metal detector 110 may include functionality for modifying the set of features included in the current product profile, rather than replacing the current product profile with a new product profile. In embodiments, the modification of the set of features included in the current product profile may include adding a new feature to the current product profile from the set of available features, enabling a previously disabled feature, disabling an active feature, removing an unwanted feature, and/or changing the level of an existing feature of the current product profile.

For example, the current product profile of the user-reconfigurable metal detector 110 may include the Multi-Frequency feature configured at the first level (e.g., using two frequencies). In this example, the user may decide to upgrade the Multi-Frequency feature from the first level to a higher level, such as the second level that utilizes four frequencies. This upgrade may be performed by reconfiguring the user-reconfigurable metal detector 110 to modify the Multi-Frequency feature by upgrading the feature form the first level to the second level. In another example, the current product profile of the user-reconfigurable metal detector 110 may include the Number of Tones feature configured at the second level (e.g., using five tones). In this example, the user may decide to downgrade the Number of Tones feature from the second level to a lower level, such as the first level that utilizes three tones. This downgrade may be performed by reconfiguring the user-reconfigurable metal detector 110 to modify the Multi-Frequency feature by downgrading the feature form the second level to the first level.

In still another example, the current product profile of the user-reconfigurable metal detector 110 may not include the Iron Volume feature. In this example, the user may decide to enable the Iron Volume feature, in which case the user-reconfigurable metal detector 110 may be reconfigured to enable the Iron Volume feature. In yet another example, the current product profile of the user-reconfigurable metal detector 110 may include the Screen Backlight feature. In this example, the user may decide to disable the Screen Backlight feature, in which case the user-reconfigurable metal detector 110 may be reconfigured to disable the Screen Backlight feature.

In some embodiments, the user-reconfigurable metal detector system 100 may support financial transactions that allow for a refund to be issued to the user when a feature is removed or downgraded from the set of features with which the user-reconfigurable metal detector 110 may be configure. This refund mechanism may be particularly advantageous as it provides users with the opportunity to trial features or upgrades. If a user is not satisfied with a newly added feature or an upgrade, they can opt to remove or downgrade it and receive a refund for the value of the feature, as determined by the system. This approach may encourage users to experiment with different configurations, secure in the knowledge that they can revert changes without financial penalty.

In embodiments, the refund process may be facilitated through the functionality of the update system 105, which may include the functionality of the backend system 150 to manage the financial aspects of feature modifications. When a user decides to remove or downgrade a feature, a request may be initiated to the backend system 150, which may process the refund according to the value of the feature and the user account details. The refund amount may be credited back to the user account, providing a monetary return that reflects the change in the product profile's configuration.

The refund functionality of the user-reconfigurable metal detector system 100 not only enhances the user experience by offering a customizable and adaptable metal detector but also presents a cost-effective solution. Users may invest in a metal detector with confidence, knowing that they have the flexibility to modify its features and receive refunds for changes that do not meet their expectations. The ability to trial features and upgrades before committing to them adds a layer of assurance and satisfaction for users, making the user-reconfigurable metal detector 110 a smart choice for users of all levels.

With reference to FIG. 2A, the reconfiguration manager 136 may be configured to manage the reconfiguration of the user-reconfigurable metal detector 110. In embodiments, the reconfiguration manager 136 may be configured to facilitate communication between the user-reconfigurable metal detector 110 and the local installer 180, ensuring that the process of reconfiguration is executed properly. In embodiments, the reconfiguration manager 136 may operate as the command center within the user-reconfigurable metal detector 110 for managing the reconfiguration process.

In embodiments, the reconfiguration manager 136 may be configured to handle the downloading of software codes or files that may be configured for the reconfiguration process. This may include retrieving the latest updates or feature sets from the local installer 180, which may as an intermediary between the user-reconfigurable metal detector 110 and the backend system 150. Once the appropriate software is downloaded, the reconfiguration manager 136 is configured to execute the code within the user-reconfigurable metal detector 110 for reconfiguring the user-reconfigurable metal detector 110, effectively transforming the functionality of the user-reconfigurable metal detector 110 in accordance with the reconfiguration request.

In embodiments, the reconfiguration process within the user-reconfigurable metal detector 110 may include the installation of new features that enhance the user-reconfigurable metal detector 110's performance or the activation of previously disabled features. For example, if a user wishes to add a Volume Control feature to their current product profile, the reconfiguration manager 136 may be configured to manage the download of the corresponding software from the local installer 180 and to execute the code to integrate this feature into the user-reconfigurable metal detector 110's operation. Similarly, if a user decides to enable a Screen Backlight feature that was previously disabled, the reconfiguration manager 136 may the execution the reconfiguration within the user-reconfigurable metal detector 110 to activate this feature.

In embodiments, the reconfiguration manager 136 may be configured to ensure that any code or files downloaded are compatible with the existing hardware and software of the user-reconfigurable metal detector 110. The reconfiguration manger 136 may perform checks and validations to confirm that the new configurations will function as intended, maintaining the integrity and reliability of the user-reconfigurable metal detector 110. In the event that a reconfiguration requires a more complex update, the reconfiguration manager 136 may coordinate with the local installer 180 to obtain the appropriate files and execute them in a manner that aligns with the user-reconfigurable metal detector 110's configuration.

With reference back to FIG. 1, the update system 105 may be configured to provide and manage the reconfiguration process of the user-reconfigurable metal detector 110. The update system 105 may be configured to implement the process of reconfiguring the user-reconfigurable metal detector 110 in accordance with embodiments of the present disclosure.

In embodiments, the reconfiguration process of the user-reconfigurable metal detector 110 may begin with the validation and authentication of the user. The update system 105 may employ robust security protocols to verify the identity of the user, ensuring that unauthorized individuals cannot access or modify the metal detector's configurations. Once the user is authenticated, the update system 105 may proceed to detect and identify the connected metal detector. This may involve validating the metal detector's serial number, model, and current software version to ensure compatibility with the available updates and features.

Upon successful identification of the metal detector, the update system 105 may present the user with the set of available features associated with the identified metal detector. This set of available features associated with the identified metal detector may include a comprehensive list of features related to functionalities that the metal detector's hardware and software can support, ranging from basic operational modes to advanced detection capabilities. The system also displays the set of available product profiles, each configured to support different classification of metal detecting operations, use cases, user preferences, etc.

In embodiments, the update system 105 may provides the user with an overview of the set of features currently enabled for the identified metal detector. This may allow the user to assess their current configuration and make informed decisions about potential modifications. Users may be enabled to select features to change, enable, add, remove, or disable from the set of features currently enabled for the metal detector, customizing their metal detector to their desired specifications.

For users looking to expand their metal detector's capabilities, the update system 105 may facilitates the purchase of new features. This may include financial transactions, where users can buy access to advanced features or additional functionalities that were not included in their original purchase. Similarly, users can purchase and install new product profiles, which provide a pre-configured set of features optimized for specific metal detecting operations or applications.

In embodiments, the final stage of the reconfiguration process may be executed by leveraging the functionality of the reconfiguration manager 136 within the metal detector, which may be configured to implement the reconfiguration. Th reconfiguration may include changing the level of an existing feature, enabling or adding new features, removing or disabling unwanted features, or replacing the current product profile with a new one.

Through the functionality of the update system 105, the reconfigurable metal detector system 100 provides a dynamic and adaptable solution to address the challenges and deficiencies of current metal detection systems. Due to the functionality of the update system 105, users may enjoy a tailored metal detecting experience, with the ability to modify their device's capabilities as their skills develop or as they explore new metal detecting applications.

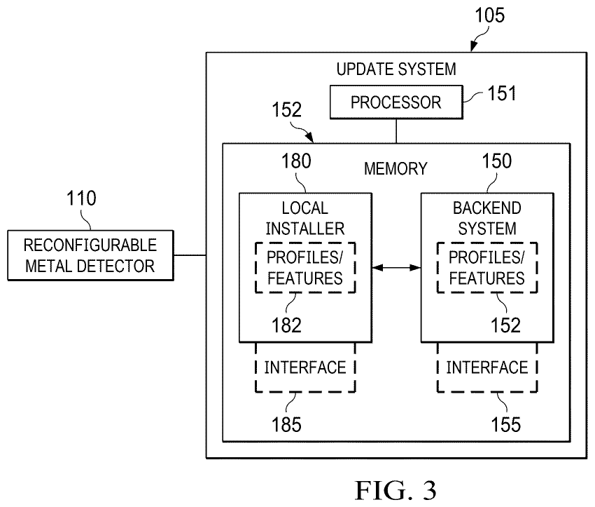

The functionality of the update system 105 will now be discussed with reference to FIG. 3. FIG. 3 is a block diagram of an exemplary update system 105 configured with capabilities and functionality for reconfiguring a user-reconfigurable metal detector in accordance with embodiments of the present disclosure.

It is noted that the functional blocks, and components thereof, of the update system 105 illustrated in FIG. 3 may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of the update system 105 illustrated in FIG. 3 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices. For example, in some embodiments, the functionality of the local installer 180 and the functionality of the backend system 150 may be implemented in different computing devices. For example, the functionality of the local installer 180 may be implemented in a user device, while the functionality of the backend system 150 may be implemented in a server that is separate and distinct from the user device.

It is further noted that functionalities described with reference to each of the different functional blocks of the update system 105 illustrated in FIG. 3 described herein is provided for purposes of illustration, rather than by way of limitation and that functionalities described as being provided by different functional blocks may be combined into a single component or may be provided via computing resources disposed in a cloud-based environment accessible over a network.

As shown in FIG. 3, the update system 105 may include processor 151, memory 152, local installer 180, and backend system 150. The processor 151 may comprise a processor, a microprocessor, a controller, a microcontroller, a plurality of microprocessors, an ASIC, an ASSP, or any combination thereof, and may be configured to execute instructions to perform operations in accordance with the disclosure herein. In some embodiments, implementations of the processor 151 may comprise code segments (e.g., software, firmware, and/or hardware logic) executable in hardware, such as a processor, to perform the tasks and functions described herein. In yet other embodiments, the processor 151 may be implemented as a combination of hardware and software. The processor 151 may be communicatively coupled to the memory 152.

The memory 152 may comprise one or more semiconductor memory devices, ROM devices, RAM devices, one or more HDDs, flash memory devices, SSDs, EROM, CD-ROM, optical disks, other devices configured to store data in a persistent or non-persistent state, network memory, cloud memory, local memory, or a combination of different memory devices. The memory 152 may comprise a processor readable medium configured to store one or more instruction sets (e.g., software, firmware, etc.) which, when executed by a processor (e.g., one or more processors of the processor 151), perform tasks and functions as described herein.

Backend system 150 may be configured to provide functionality for managing and organizing the set of available features and product profiles for the user-reconfigurable metal detector 110. In embodiments, the backend system 150 may manage distinct sets of available features and product profiles (e.g., profiles/features 152) for each of a plurality of reconfigurable metal detectors. This functionality allows for a tailored approach where each metal detector can be customized with a specific set of features and product profiles that align with the user's metal detecting activities and the capabilities of the hardware.

For example, each of the plurality of reconfigurable metal detectors may include a set of hardware components that is fixed and is not to be modified post-manufacture. These hardware components may form a common hardware platform that supports a wide range of functionalities for each reconfigurable metal detector. Despite the fixed nature of the hardware, each of the reconfigurable metal detectors may be configured to be dynamically adaptable and reconfigurable through software reconfiguration. This functionality enables the reconfigurable metal detectors to be reconfigured for different classifications of metal detecting operations without the replacement of hardware components, in accordance with embodiments of the present disclosure.

In embodiments, the backend system 150, through its interface 155, may facilitate the reconfiguration process by enabling users to access and select from the set of available features and product profiles. The backend system 150 operates to ensure that the features and profiles are compatible with the identified metal detector's hardware platform, and may manage the distribution of software updates, patches, and/or commands that enable the reconfiguration. In embodiments, the backend system 150 maintains a database of user profiles, purchase history, and device configurations, which may assist in providing a personalized and efficient reconfiguration experience.

In embodiments, the functionality of backend 150 may be leveraged by users to obtain flexibility in their metal detecting operations. For example, a user may initially configure their metal detector for general-purpose treasure hunting but later may reconfigure it for specialized applications such as gold prospecting or archaeological surveys. The backend system 150 may support this flexibility by providing users with the ability to switch between product profiles that are optimized for different metal detecting applications, all while utilizing the same underlying hardware platform.

In embodiments, the backend system 150 may be configured to present, via the user interface 155, the set of available features and product profiles associated with the user-reconfigurable metal detector 110. In this manner, the user interface 155 (e.g., which may be part of the user terminal 130 or accessible through a web portal) may provide a visual representation of the reconfiguration or customization options available for user-reconfigurable metal detector 110. The set of available features associated with the user-reconfigurable metal detector 110 may include a set of the functionalities and features that the metal detector's hardware and software are capable of supporting, including those that can be authorized for use on the user-reconfigurable metal detector 110.

In embodiments, an authorized feature for the user-reconfigurable metal detector 110 may include any feature that has been purchased or is available for free. Once a feature is authorized, the feature can be installed, added, or enabled for the user-reconfigurable metal detector 110. Some features, although authorized and even installed, may be disabled or deactivated depending on the user's preferences or the specific requirements of a metal detecting session. This flexibility allows users to tailor their metal detector's functionality to their current situation.

The backend system 150 also manages the product profiles associated with the reconfigurable metal detector 110. Each product profile is a curated collection of features configured to provide a particular classification of metal detecting operations, such as metal detecting applications and or performance levels. In embodiments, each product profile includes a different set of features and capabilities, and the backend system 150 ensures that the appropriate product profiles are available for installation on the user-reconfigurable metal detector 110. Users can select a product profile that aligns with their metal detecting goals, whether they are searching for lost jewelry on the beach, uncovering coins in a park, or prospecting for gold in rugged terrain. In embodiments, an authorized product profile may include any product profile that has been purchased or is available for free. Once a product profile is authorized, the product profile can be installed on the user-reconfigurable metal detector 110.

In embodiments, the backend system 150 may be configured to receive requests for reconfiguration of the user-reconfigurable metal detector 110. Through the user interface 155, users may initiate a request to modify the current product profile of the user-reconfigurable metal detector 110. For example, a user may log into their account via the user interface 155. The functionality of the backend server 150 operates to present detailed information about the user-reconfigurable metal detector 110 to the user, including the current product profile and the features that are currently authorized for use on the metal detector. This information provides a clear overview of the metal detector's capabilities and serves as a starting point for any desired modifications. The backend system 150 may present the user with a list of available features associated with the user-reconfigurable metal detector 110, which may include all or a subset of all features that the metal detector is capable of supporting, regardless of whether they have been previously authorized, installed, or purchased.

The functionality of the backend server 150 operates to enable users to select features for modification from the list of available features associated with the user-reconfigurable metal detector 110. The type of modification may vary depending on the user's specific requirements. For example, adding a feature to the set of features of the current product profile may involve purchasing the feature if it is not yet authorized. Conversely, removing a feature from the set of features may result in the system providing a mechanism for the user to receive a refund of the value of the removed feature. This financial transaction may be managed by the backend system 150.

In embodiments, a request to change a feature of the current product profile may include a request to upgrade the feature to enhance its functionality or a request to downgrade the feature to a lower level. In embodiments, upgrading a feature may require an additional purchase, while downgrading may trigger a refund to the user for the difference in value.

In embodiments, a request to enable a feature of the set of features of the current product profile may include a request to activate the functionality provided by that feature, making it available for use during metal detecting operations. Conversely, a request to disable a feature may include a request to deactivate its functionality, ensuring that the metal detector operates without the influence of that particular feature. It is noted that in some embodiments, disabling a feature may be different from removing the feature, in that disabling the feature may simply deactivate the feature, while removing the feature may uninstall the feature from the metal detector, eliminating the option to enable it in the future.

In embodiments, the request to reconfigure the user-reconfigurable metal detector 110 may include a request to replace the current product profile with a new product profile. For example, when a user desires to replace the current product profile of the user-reconfigurable metal detector 110 with a new one, the user may log into their account via the user interface 155. Upon successful login, the user may be presented with the details of their metal detector, including the current product profile and the features that are currently authorized and active on the metal detector.

The backend system 150 may present the user with a comprehensive list of available product profiles for the user-reconfigurable metal detector 110. This list may include various configurations of product profiles, each configured to optimize the user-reconfigurable metal detector 110 for specific classifications of metal detecting operations. The user may browse through these product profiles, which may range from basic setups ideal for beginners to advanced configurations suitable for experienced metal detecting enthusiasts. Each product profile is a curated combination of features that, when activated, may dictate the operational behavior of the metal detector.

Once the user selects a new product profile, the backend system 150 processes the request to install the chosen profile on the metal detector, replacing the current product profile. This installation may involve downloading and executing new software codes or files that reconfigure the user-reconfigurable metal detector 110's settings and activates the features included in the new product profile. In embodiments, the reconfiguration manager 136 within the user-reconfigurable metal detector 110 may ensure that the transition to the new product profile is executed properly, updating the user-reconfigurable metal detector 110's software and adjusting its operational parameters to reflect the new product profile.

In embodiments, the backend system 150 may be configured to authorize features and/or product profiles for the user-reconfigurable metal detector 110. In embodiments, authorization of a feature or product profile may enable the user to utilize the selected functionalities on their metal detector. When a feature and/or product profile has been purchased, the backend system 150 authorizes it for use, effectively unlocking the new capabilities for user-reconfigurable metal detector 110. The authorization functionality of the backend system 150 may operate to ensure that users have legitimate access to the features they have acquired, while preventing unauthorized access.

In addition, or in the alternative, to purchased features, the backend system 150 may manage the authorization of free features and product profiles. These freely available options may expand the functionality of the user-reconfigurable metal detector 110 without requiring financial transactions. The backend system 150 may authorize these free features and product profiles in a similar manner to purchased ones, ensuring that users can access and utilize these functionalities whether or not they have been purchased.

In embodiment, the functionality of the backend system 150 to authorize features and/or product profiles may include the generation of a validation key, which may represent the formal authorization of a feature or product profile. This validation key may represent a secure token that may be generated based on a secret associated with the metal detector and the feature or product profile to be authorized. The secret may include a combination of codes, such as an ID, a unique number, a cryptographic key, or a certification, that are uniquely associated with the metal detector and the feature or product profile. By using this secret, the backend system 150 may generate a validation key that authorizes the feature or product profile for use on the metal detector.

In embodiments, the validation keys operate to ensure that features and product profiles are authorized in a controlled and secure manner, preventing unauthorized access and use. The backend system 150 may use the validation keys to verify that the metal detector is entitled to operate with the authorized features and product profile.

In embodiments, the backend system 150 may be configured to validate requests for reconfiguration of the user-reconfigurable metal detector 110, which may operate to ensure that modifications to the user-reconfigurable metal detector 110's features and product profiles are authorized and legitimate. In embodiments, the functionality to validate requests or reconfiguration may include a multi-step procedure that begins when a user, through the local installer 180 or via the user interface 155 of the backend system 250, submits a request to reconfigure the user-reconfigurable metal detector 110. This reconfiguration request may include a variety of modifications, such as enabling a new feature, adding an additional capability, upgrading an existing feature to enhance its performance, or replacing the current product profile with a new one tailored to different metal detecting operations.

Upon receiving a reconfiguration request, the backend system 150 may proceed to validate the reconfiguration request by verifying the secret associated with the metal detector. The secret may include a secure identifier that may include a combination of the metal detector's serial number, a user-specific code, and/or other cryptographic elements combined with a code and/or other cryptographic element associated with the feature or product profile associated with the reconfiguration request. In this manner, the secret may uniquely link the reconfiguration request to the specific metal detector and the selected feature or product profile.

Once the secret is provided, the backend system 150 may generate a validation key based on this secret. The validation key may include a digital signature that serves as proof of authorization for the requested modification. In some embodiments, the backend system 150 may compare the generated validation to existing keys associated with the metal detector to determine the legitimacy of the request. If the validation matches an existing validation for the metal detector, this may signify that the requested modification, such as the addition of a feature or the installation of a new product profile, has been authorized for that particular metal detector.

In the event that the validation is successful, the backend system 150 may authorize the reconfiguration request, allowing the local installer 150 and the reconfiguration manager 136 to proceed with the implementation of the changes. This may involve downloading the relevant software components, updating the metal detector's firmware, and/or activating the newly authorized features or product profile. In some embodiments, the user may be notified of the successful authorization, and the user-reconfigurable metal detector 110 may be updated to reflect the new configuration.

On the other hand, if the validation key does not match any existing validation keys for the user-reconfigurable metal detector 110, this may signify that the requested modification has not been authorized. In such cases, the backend system 150 may deny the reconfiguration request, and the user may be informed that the modification cannot be carried out.

Local installer 180 may be configured to operate as an intermediary between the backend system 150 and the user-reconfigurable metal detector 110 to manage operations related to the reconfiguration of the user-reconfigurable metal detector 110. In embodiments, the local installer 180 may be communicatively coupled to the user-reconfigurable metal detector 110, facilitating direct interaction with the device's hardware and software systems.

In embodiments, the local installer 180 is configured to operate as a secure communication conduit between the metal detector and the backend system 150. The local installer 180 may operate to ensure that all data transmitted during the reconfiguration process is encrypted and protected from unauthorized access. This includes the handling of validation keys and secrets associated with the user-reconfigurable metal detector 110, which may be used to authorize and/or validate the reconfiguration requests.

In embodiments, the local installer 180 may be configured to establish communications with the user-reconfigurable metal detector 110 through various connectivity options. For example, the local installer 180 may be configured to establish communications with the user-reconfigurable metal detector 110 using a direct connection such as via a USB interface, which provides a reliable and fast data transfer method for updating software or modifying features. Additionally, or alternatively, the local installer 180 may connect to the user-reconfigurable metal detector 110 using Bluetooth technology, WIFI technology, serial communications, and/or other communication protocols, such as described with reference to the network 145.

For example, in embodiments, the local installer 180 may be configured to establish a direct connection with the user-reconfigurable metal detector 110. This direct connection may be configured to facilitate the exchange of information between the user-reconfigurable metal detector 110 and the local installer 180, enabling the local installer 180 to perform a variety of functions to facilitate the reconfiguration of the user-reconfigurable metal detector 110. In embodiments, upon establishing a connection, the local installer 180 may be configured to retrieve information from the user-reconfigurable metal detector 110.

In embodiments, the information retrieved from the user-reconfigurable metal detector 110 by the local installer may include information related to an identification of the user-reconfigurable metal detector 110. In embodiments, the identification information may include details such as the user-reconfigurable metal detector 110's serial number, model number, and/or any other identifiers that uniquely distinguish the user-reconfigurable metal detector 110. This identification information may be used to ensure that any modifications or updates are compatible with the user-reconfigurable metal detector 110, and/or to validate the reconfiguration requests associate with the user-reconfigurable metal detector 110.

In embodiments, the information retrieved from the user-reconfigurable metal detector 110 by the local installer may include information related the current product profile of the user-reconfigurable metal detector 110. In embodiments, the information related the current product profile of the user-reconfigurable metal detector 110 may include the set of features that are currently active and available for use on the user-reconfigurable metal detector 110. This set of features may include both the operational modes and the specific functionalities that are enabled on the metal detector, such as discrimination settings, sensitivity levels, and audio feedback options.

In embodiments, the local installer 180 may be configured to provide a user interface 185 that may operate as a point of interaction for users seeking to reconfigure the user-reconfigurable metal detector 110. In embodiments, the user interface 185 may include a graphical interface through which the local installer 180 may presents detailed information about the metal detector, including its current product profile and the set of features that are active or available for activation.

In embodiments, the user interface 185 may be configured to enable users to initiate requests for reconfiguration of the user-reconfigurable metal detector 110. These reconfiguration requests may include requests ranging from a request to modify an existing feature within the current product profile to a request to install a completely new product profile that aligns with different metal detecting operations or user preferences.

In embodiments, the user interface 185 provided by the local installer 180 may facilitate the selection and customization process, allowing users to choose from the set of available features and product profiles. Once the user makes their selection, the local installer 180 may process the request by communicating with the backend system 150 to obtain the authorization and validation keys for the requested modifications. After successful validation, the local installer 180 manages the download and installation of the new features or product profiles, updating the metal detector's firmware and software as appropriate.

In embodiments, the configuration of the local installer 180 to validate the reconfiguration request may include functionality to validate the compatibility of the requested reconfiguration (e.g., the selected feature and/or product profile) with the user-reconfigurable metal detector 110's existing hardware and software configuration. In embodiments, the local installer 180 may perform checks to confirm that the new configurations will function as intended, maintaining the integrity and reliability of the user-reconfigurable metal detector 110. Once validation is complete, the local installer 180 oversees the installation of the new features or product profiles, executing the software updates and adjusting the operational parameters of the metal detector accordingly.

In embodiments, the configuration of the local installer 180 to validate the reconfiguration request may include functionality to query the metal detector for a secret. In embodiments, this secret may include a secure identifier that may include a code, an ID, a cryptographic certificate, or any other form of data that is uniquely associated with the user-reconfigurable metal detector 110 combined with a code, ID, cryptographic certificate, or any other form of data that is uniquely associated with the feature or product profile associated with the reconfiguration request. For example, in embodiments, the secret may be a composite identifier formed from the metal detector's ID combined with an ID that is related to the selected feature or product profile.

Upon receiving the secret from the metal detector, the local installer 180 may forward this information to the backend system 150. The backend system 150 may be configured to transform the secret into a validation key. This validation process involves the backend system 150 applying a set of algorithms or cryptographic methods to the secret to generate a digital signature or token that serves as the validation key. The validation key is then validated by the backend system 150.

If the validation is successful and the validation key is deemed valid, it signifies that the selected feature or profile has been enabled for the metal detector. Consequently, the backend system 150 may send a signal to the local installer 180 to proceed with the reconfiguration of the user-reconfigurable metal detector 110. The local installer 180 then executes the appropriate actions to add, install, or activate the selected feature or product profile on the user-reconfigurable metal detector 110. This may include downloading the relevant software components, updating the metal detector's firmware, and adjusting its operational parameters to incorporate the new functionality.

Conversely, if the validation key is deemed invalid, this may signify that the selected feature or product profile has not been authorized for the user-reconfigurable metal detector 110. In such a case, the backend system 150 may send a failure signal to the local installer 180. The local installer 180, upon receiving this failure signal, may refrain from making any changes to the user-reconfigurable metal detector 110's configuration. The selected feature or product profile may not be activated, installed, or otherwise enabled in the user-reconfigurable metal detector 110.

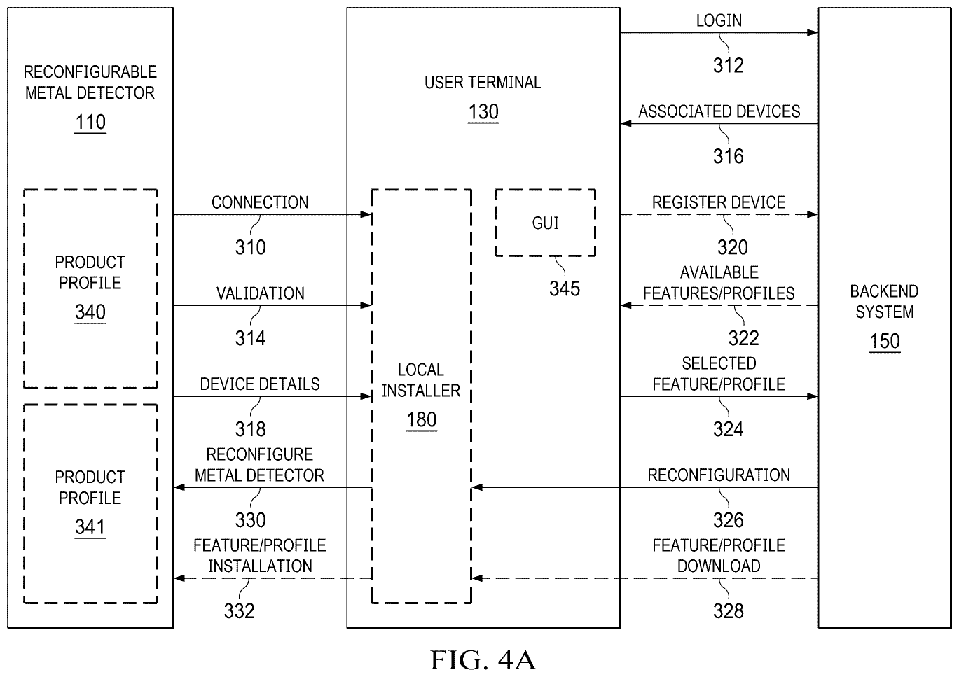

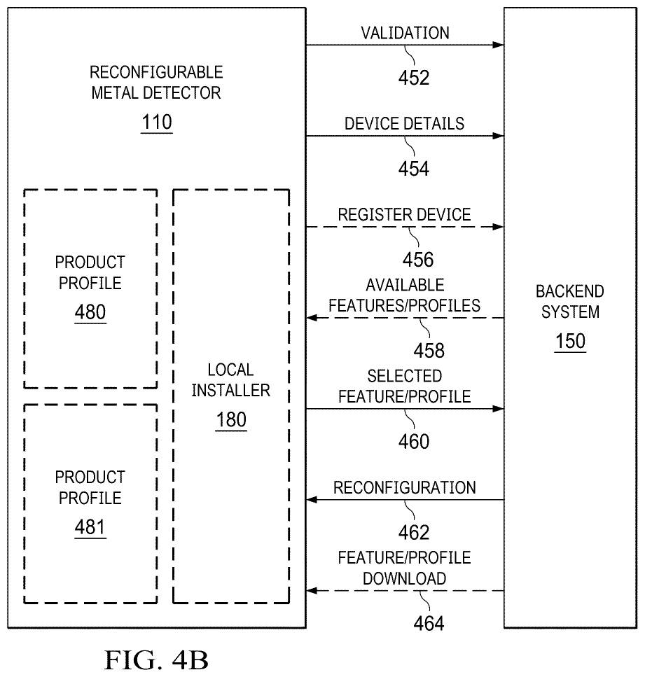

FIG. 4A illustrates a sequence diagram that shows exemplary operations for reconfiguring a reconfigurable metal detector 110 in accordance with embodiments of the present disclosure. The diagram shown in FIG. 4A provides a visual representation of the interactions between the user, the user-reconfigurable metal detector 110, the user terminal 130, the local installer 180, and the backend system 150 during the reconfiguration process. The diagram captures the flow of information and commands that are exchanged through the various stages of reconfiguring the user-reconfigurable metal detector 110, from initiating a reconfiguration request to the successful implementation of the desired changes. In the configuration illustrated in FIG. 4A, the local installer 180 may be provided as part of the user terminal 130, in which case the local installer 180 may operate as a client hosted by the user terminal 130.

As shown in FIG. 4A, the user-reconfigurable metal detector 110 may be configured with a current product profile 340, which may include a set of features. To facilitate the interaction with the metal detector's configuration, the user terminal 130 may include a graphical user interface (GUI) 345. The GUI 345 may represent the user interface provided by the backend system 150, and additionally, or alternatively, the GUI 345 may represent the user interface provided by the local installer 180. Through the GUI 345, users can initiate requests for reconfiguration, select new features or product profiles, and/or manage the customization of their metal detector.

The reconfiguration sequence may begin at connection 310, during which the user-reconfigurable metal detector 110 may establish a direct connection with the local installer 180. In embodiments, the connection between the user-reconfigurable metal detector 110 and the local installer 180 may enable the local installer 180 to communicate directly with the user-reconfigurable metal detector 110's hardware and software systems. The connection may be facilitated through various means such as USB, Bluetooth, WIFI, or serial communications, depending on the user's setup and the user-reconfigurable metal detector 110's capabilities.

In some embodiments, once the connection is established, the local installer 180 may initiates a handshake protocol to ensure secure communication with the user-reconfigurable metal detector 110. This protocol may involve the exchange of authentication credentials, such as digital certificates or passwords, to verify the identity of the metal detector and confirm that it is authorized to undergo reconfiguration. The handshake may also operate to establish an encrypted communication channel, protecting the integrity of the data exchanged during the reconfiguration process.

At device details 318, the local installer 180 may retrieve detailed information from the user-reconfigurable metal detector 110. This information may include identification details of the user-reconfigurable metal detector 110, such as its serial number and model, and information related to the current product profile 340 of the user-reconfigurable metal detector 110, which may include the set of features that are active or available for activation. In embodiments, the local installer 180 may presents the user with the set of available features and product profiles that can be installed or activated on the metal detector. Through the user interface 345, users can select desired modifications to request reconfiguration of the user-reconfigurable metal detector 110.

At login 312, the user may interact with the user interface 345 to access a user account. This may include entering user credentials such as a username and password, which are then authenticated by the backend system 150 to grant access to the user's account. Once logged in, the user may be presented with a dashboard or control panel that displays information related to the user account. For example, at associated devices 316, the user may be presented with a list of metal detector devices associated with their account via the GUI 345. This list may be generated by the backend system 150, which may retrieve the information from a database where details of all devices registered to the user may be stored. The GUI 345 may display each associated device along with pertinent information such as the device's model, serial number, and current product profile. In embodiments, the user may be enabled to interact with the GUI 345 to select one of the associated devices to view more detailed information. Upon selection, the backend system 150 may provide a comprehensive overview of the chosen device, including its operational history, installed features, and any available updates or upgrades.

At device registration 320, the user may be enabled to register a new device that is not yet associated with their user account. In some embodiments, this step in the sequence may occur in response to the local installer 180 determining, based on the device details retrieved at 318, that the user-reconfigurable metal detector 110 is not currently associated with the user's account. In other embodiments, this step may be initiated by the user to register a new metal detector. The local installer 180 communicates this information to the user via the GUI 345, prompting the user to initiate the device registration process.

At available features/profiles 322, the backend system 150 may present the user with a list of available features and product profiles for the user-reconfigurable metal detector 110 via the GUI 345. This list may represent a spectrum of enhancements and customizations that the user can apply to the user-reconfigurable metal detector 110, including both features that are currently authorized for use and those that may be available for purchase or as free upgrades.

The GUI 345 may operate to allow the user to browse through the available features and product profiles (e.g., in some embodiments providing descriptions and potentially previews of the functionalities each option offers). In some embodiments, the GUI 345 may offer recommendations based on the user's previous metal detecting activities or preferences. Once the user makes their selections, the GUI 345 may facilitate the submission of the reconfiguration request to the backend system 150.

For example, at selected feature/profile 324, a reconfiguration request may be initiated by the user selection of a feature to be modified and/or a product profile to be installed. The reconfiguration request may represent the user-driven action that reflects the user's desire to modify the metal detector's functionality to better align with their metal detecting requirements or to adapt to new metal detecting environments. The GUI 345 captures the user's selection and communicates the user selection to the backend system 150 as a reconfiguration request.

In embodiments, the backend system 150 may processes the reconfiguration request. In embodiments, processing the reconfiguration request may include validating the reconfiguration request against the metal detector's capabilities and the user account status. The validation may also include validating whether the reconfiguration request is valid or not. For example, at validation 314, the validation of the reconfiguration request may involve the backend system 150 generating validation keys based on the user's selections and a secret provided by the user-reconfigurable metal detector 110 (e.g., at secret 319). The validation process at validation 314 may be similar to the validation process describe with respect to the functionality of the update system 105 above.

Upon successful validation, the backend system 150 may authorize the local installer 180 to proceed with the reconfiguration process at reconfiguration 326. In some embodiments, the reconfiguration may include downloading the new features or product profiles by the local installer 180 at 328 to be provided to the user-reconfigurable metal detector 110.

At reconfiguration command 330, the local installer 180, having received authorization from the backend system 150, may execute the reconfiguration of the reconfigurable metal detector 110 in cooperation with the reconfiguration manager 136. The local installer 180 may send a reconfiguration command to the reconfiguration manager 136, which may cause the reconfiguration manager 136 to initiate, at 332, the reconfiguration process by executing the appropriate software routines. This may involve installing new software modules, updating existing firmware, and/or activating previously dormant features within the user-reconfigurable metal detector 110. The reconfiguration manager 136 operates to ensure that the changes are applied correctly and that the user-reconfigurable metal detector 110's functionality is updated to reflect the new configuration.

In some embodiments, the local installer 180 may communicate the successful reconfiguration to the user via the GUI 345. The user may be informed that the user-reconfigurable metal detector 110 has been reconfigured according to the reconfiguration request, and the updated product profile, such as product profile 341, is now active. This updated profile 341 enables the user to utilize the new features and capabilities during their metal detecting activities.

FIG. 4B illustrates a sequence diagram that shows exemplary operations for reconfiguring a reconfigurable metal detector 110 in accordance with embodiments of the present disclosure. The sequence of operations illustrated in FIG. 4B is similar to those depicted in FIG. 4A, with a notable distinction in the configuration of the local installer 180. In the embodiment illustrated in FIG. 4B, the local installer 180 is provided as part of the user-reconfigurable metal detector 110 itself, enabling the user-reconfigurable metal detector 110 to communicate directly with the backend system 150. This direct communication capability allows for the reconfiguration of the user-reconfigurable metal detector 110 without the intermediary use of a user terminal, streamlining the process and enhancing the user experience.

The integrated approach of the embodiment illustrated in FIG. 4B may operate to simplify the reconfiguration process by eliminating the dependency on an external user terminal, allowing users to reconfigure the user-reconfigurable metal detector 110 to customize features and product profiles on-the-go. The local installer 180's direct communication with the backend system 150 may operate to ensure that the latest features and updates are readily accessible.

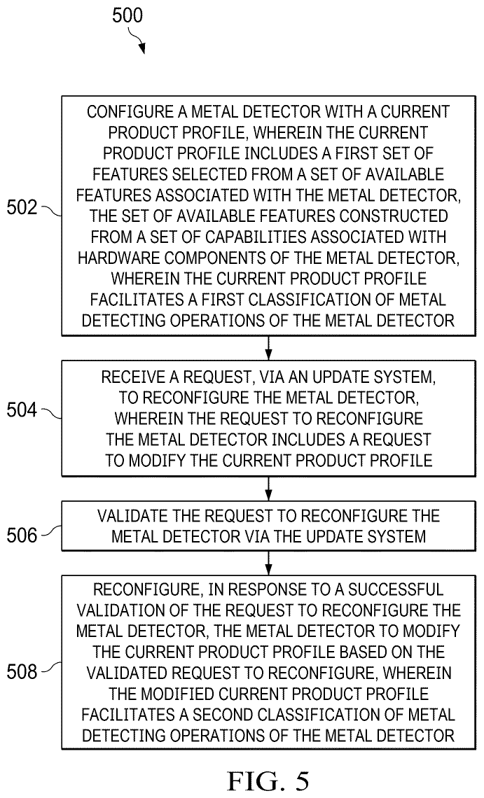

FIG. 5 shows a high-level flow diagram 500 of operation of a system configured for providing functionality for reconfiguring a user-reconfigurable metal detector in accordance with embodiments of the present disclosure. For example, the functions illustrated in the example blocks shown in FIG. 5 may be performed by system 100 of FIG. 1 according to embodiments herein. In embodiments, the operations of the method 500 may be stored as instructions that, when executed by one or more processors, cause the one or more processors to perform the operations of the method 500.

At block 502, a metal detector is configured with a current product profile. In embodiments, the current product profile includes a first set of features selected from a set of available features associated with the metal detector, the set of available features is constructed from a set of capabilities associated with hardware components of the metal detector, and the current product profile facilitates a first classification of metal detecting operations of the metal detector. In embodiments, functionality of an update system (e.g., update system 105 as illustrated in FIG. 1) may be used to configure a metal detector with a current product profile. In embodiments, the update system may perform operations to configure a metal detector with a current product profile according to operations and functionality as described above with reference to update system 105 and as illustrated in FIGS. 1-4B.

At block 504, a request to reconfigure the metal detector is received. In embodiments, the request to reconfigure the metal detector includes a request to modify the current product profile. In embodiments, functionality of an update system (e.g., update system 105 as illustrated in FIG. 1) may be used to receive a request to reconfigure the metal detector. In embodiments, the update system may perform operations to receive a request to reconfigure the metal detector according to operations and functionality as described above with reference to update system 105 and as illustrated in FIGS. 1-4B.

At block 506, the request to reconfigure the metal detector is validated. In embodiments, functionality of an update system (e.g., update system 105 as illustrated in FIG. 1) may be used to validate the request to reconfigure the metal detector via the update system. In embodiments, the update system may perform operations to validate the request to reconfigure the metal detector via the update system according to operations and functionality as described above with reference to update system 105 and as illustrated in FIGS. 1-4B.

At block 508, the metal detector is reconfigured, in response to a successful validation of the request to reconfigure the metal detector, to modify the current product profile based on the validated request to reconfigure. In embodiments, the modified current product profile facilitates a second classification of metal detecting operations of the metal detector. In embodiments, functionality of an update system (e.g., update system 105 as illustrated in FIG. 1) may be used to reconfigure, in response to a successful validation of the request to reconfigure the metal detector, the metal detector to modify the current product profile based on the validated request to reconfigure. In embodiments, the update system may perform operations to reconfigure, in response to a successful validation of the request to reconfigure the metal detector, the metal detector to modify the current product profile based on the validated request to reconfigure according to operations and functionality as described above with reference to update system 105 and as illustrated in FIGS. 1-4B.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-5 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of reconfiguring a metal detector, comprising:
configuring a metal detector with a current product profile, wherein the current product profile includes a first set of features selected from a set of available features associated with the metal detector, the set of available features constructed from a set of capabilities associated with hardware components of the metal detector, wherein the current product profile facilitates a first classification of metal detecting operations of the metal detector;
receiving a request, via an update system, to reconfigure the metal detector, wherein the request to reconfigure the metal detector includes a request to modify the current product profile;
validating the request to reconfigure the metal detector via the update system; and
reconfiguring, in response to a successful validation of the request to reconfigure the metal detector, the metal detector to modify the current product profile based on the validated request to reconfigure, wherein the modified current product profile facilitates a second classification of metal detecting operations of the metal detector.

2. The method of claim 1, wherein the request to modify the current product profile includes a request to replace the current product profile with a different product profile including a second set of features selected from the set of available features, wherein the second set of features is different from the first set of features, and wherein the different product profile facilitates the second classification of metal detecting operations of the metal detector.

3. The method of claim 1, wherein modifying the current product profile includes one or more of:
upgrading a feature within the first set of features to a higher level of performance;
downgrading a feature to a lower level of performance;
adding a new feature to the first set of features;
removing a feature from the first set of features;
enabling a previously disabled feature of the first set of features; and
disabling an active feature of the first set of features, wherein the modification of the set of features results in a modified product profile that facilitates the second classification of metal detecting operations of the metal detector.

4. The method of claim 1, wherein the first classification of metal detecting operations is based on a performance level of the metal detector, and wherein the second classification of metal detecting operations represents a different performance level achieved by the modified current product profile, the different performance level providing one of higher detection capabilities or lower detection capabilities compared to the first classification.

5. The method of claim 1, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

6. The method of claim 1, wherein the current product profile is configured for a specific type of metal detecting operation selected from the group consisting of:
relic hunting;
law enforcement;
gold prospecting;
coin hunting;
beach metal detecting; and
underwater metal detecting.

7. The method of claim 6, wherein the request to reconfigure the metal detector includes selecting a new product profile tailored for a different type of metal detecting operation from the group, resulting in the metal detector being reconfigured to facilitate the second classification of metal detecting operations optimized for the selected different type of metal detecting operation.

8. The method of claim 1, wherein at least one feature in the first set of features is associated with multiple performance levels, and wherein modifying the current product profile includes changing the level of the at least one feature to a higher or lower performance level, resulting in the modified product profile that facilitates the second classification of metal detecting operations of the metal detector.

9. The method of claim 1, wherein the current product profile includes a feature from the set of available features that is configured as enabled, and wherein modifying the current product profile includes disabling the enabled feature, resulting in a modified product profile with the feature in a disabled state, thereby altering the functionality provided by the metal detector during the first classification of metal detecting operations.

10. A system configured for reconfiguring a metal detector, comprising:
at least one processor; and
a memory operably coupled to the at least one processor and storing processor-readable code that, when executed by the at least one processor, is configured to perform operations including:
configuring a metal detector with a current product profile, wherein the current product profile includes a first set of features selected from a set of available features associated with the metal detector, the set of available features constructed from a set of capabilities associated with hardware components of the metal detector, wherein the current product profile facilitates a first classification of metal detecting operations of the metal detector;
receiving a request, via an update system, to reconfigure the metal detector, wherein the request to reconfigure the metal detector includes a request to modify the current product profile;
validating the request to reconfigure the metal detector via the update system; and
reconfiguring, in response to a successful validation of the request to reconfigure the metal detector, the metal detector to modify the current product profile based on the validated request to reconfigure, wherein the modified current product profile facilitates a second classification of metal detecting operations of the metal detector.

11. The system of claim 10, wherein the request to modify the current product profile includes a request to replace the current product profile with a different product profile including a second set of features selected from the set of available features, wherein the second set of features is different from the first set of features, and wherein the different product profile facilitates the second classification of metal detecting operations of the metal detector.

12. The system of claim 10, wherein modifying the current product profile includes one or more of:
upgrading a feature within the first set of features to a higher level of performance;
downgrading a feature to a lower level of performance;
adding a new feature to the first set of features;
removing a feature from the first set of features;
enabling a previously disabled feature of the first set of features; and
disabling an active feature of the first set of features, wherein the modification of the set of features results in a modified product profile that facilitates the second classification of metal detecting operations of the metal detector.

13. The system of claim 10, wherein the first classification of metal detecting operations is based on a performance level of the metal detector, and wherein the second classification of metal detecting operations represents a different performance level achieved by the modified current product profile, the different performance level providing one of higher detection capabilities or lower detection capabilities compared to the first classification.

14. The system of claim 10, wherein the first classification of metal detecting operations is configured to enable a first metal detecting application, and wherein the second classification of metal detecting operations is configured to enable a second metal detecting application different from the first metal detecting application, the second metal detecting application requiring a distinct set of features for optimization.

15. The system of claim 10, wherein the current product profile is configured for a specific type of metal detecting operation selected from the group consisting of:
relic hunting;
law enforcement;
gold prospecting;
coin hunting;
beach metal detecting; and
underwater metal detecting,

16. The system of claim 15, wherein the request to reconfigure the metal detector includes selecting a new product profile tailored for a different type of metal detecting operation from the group, resulting in the metal detector being reconfigured to facilitate the second classification of metal detecting operations optimized for the selected different type of metal detecting operation.

17. The system of claim 10, wherein at least one feature in the first set of features is associated with multiple performance levels, and wherein modifying the current product profile includes changing the level of the at least one feature to a higher or lower performance level, resulting in the modified product profile that facilitates the second classification of metal detecting operations of the metal detector.

18. The system of claim 10, wherein the current product profile includes a feature from the set of available features that is configured as enabled, and wherein modifying the current product profile includes disabling the enabled feature, resulting in a modified product profile with the feature in a disabled state, thereby altering the functionality provided by the metal detector during the first classification of metal detecting operations.

19. A computer-based tool for reconfiguring a metal detector, the computer-based tool including non-transitory computer readable media having stored thereon computer code which, when executed by a processor, causes a computing device to perform operations comprising:
configuring a metal detector with a current product profile, wherein the current product profile includes a first set of features selected from a set of available features associated with the metal detector, the set of available features constructed from a set of capabilities associated with hardware components of the metal detector, wherein the current product profile facilitates a first classification of metal detecting operations of the metal detector;
receiving a request, via an update system, to reconfigure the metal detector, wherein the request to reconfigure the metal detector includes a request to modify the current product profile;
validating the request to reconfigure the metal detector via the update system; and
reconfiguring, in response to a successful validation of the request to reconfigure the metal detector, the metal detector to modify the current product profile based on the validated request to reconfigure, wherein the modified current product profile facilitates a second classification of metal detecting operations of the metal detector.

20. The computer-based tool of claim 19, wherein modifying the current product profile includes one or more of:
upgrading a feature within the first set of features to a higher level of performance;
downgrading a feature to a lower level of performance;
adding a new feature to the first set of features;
removing a feature from the first set of features;
enabling a previously disabled feature of the first set of features; and
disabling an active feature of the first set of features, wherein the modification of the set of features results in a modified product profile that facilitates the second classification of metal detecting operations of the metal detector.
